(19) United States
(12) Patent Application Publication
(10) Pub. No.: US 2012/0104993 A1
(43) Pub. Date: May 3, 2012

(54) CONTACTLESS CHARGING DEVICE, CHARGING METHOD, CHARGEABLE BATTERY, AND CHARGER

(75) Inventor: Bin HUANG, (US)

(73) Assignee: Vimicro Corporation

(21) Appl. No.: 13/337,056

(22) Filed: Dec. 24, 2011

(30) Foreign Application Priority Data
Jun. 17, 2010 (CN) PCT/CN2010/074005

(51) Int. Cl. H02J 7/00

(52) U.S. Cl. 320/106

(57) ABSTRACT

Techniques for a contactless charging device, a charging method thereof, a chargeable battery, and a charger are described. The contactless charging device includes a chargeable battery and a charger. The chargeable battery includes a secondary charging circuit configured for receiving power from the primary charging circuit and a contactless IC card configured for storing the battery characteristic information of the chargeable battery. The charger includes a contactless card reading circuit configured for reading battery characteristic information of the chargeable battery and transmitting the battery characteristic information to a charging control IC during charging, a primary charging circuit configured for transmitting power to the chargeable battery; and a charging control IC configured for controlling the primary charging circuit to supply power to the primary charging circuit according to the battery characteristic information.

### TECHNOLOGY FIELD

The invention relates to a charging device, and particularly to, a contactless charging device, a charging method, a chargeable battery, and a charger.

### BACKGROUND OF TECHNOLOGY

A contactless charging device charges an electrical device without connecting to an electrical contact, thereby effectively preventing itself from oxidization and corrosion, which result from exposure of the electrical contact. Thus, the contactless charging device is becoming an important point in current research of electric power transmission.

A contactless electric transmission unit shown in FIG. 1 is a typical contactless charging device in prior arts. The contactless electric transmission unit consists of a power supply module 101 and a power receiving module 102. The power supply module 101 includes a primary coil 111 and a controlling unit 112. The power receiving module 102 is comprised of a secondary coil 121 and a controlling unit 122. The electric transmission is implemented by using the power supply module 101 and the power receiving module 102 together.

However, the contactless device may meet following restrictions when being applied to a mobile phone. Firstly, the power receiving module 102 has to be mounted in the mobile phone when being applied to the mobile phone. The smallest size of the secondary coil 121, which ensures an acceptable charge current and transmission efficiency, may be 45 mm×35 mm×0.8 mm. Mobile phones currently on sale cannot provide enough space to accommodate the secondary coil 121 in this size. Secondly, a charge control IC 103 should be assembled into the mobile phone, because of that a lithium ion battery 104 can not be charged by a charger if the charge control IC 103 is detached from the mobile phone. Thirdly, varies of power load generated in the power supply module 101 are pre-record into the power supply module 101 according to the type of the mobile phone. If the charger solutions employed by the power supply module 101 and the power receiving module 102 are not provided by a same manufacturer, the charge can not be implemented. That is, the power supply module 101 and the power receiving module 102 must be compatible with each other, and however, lack universality.

In brief, an urgent technology problem needed to be solved by those skilled in present art to provide a contactless charging solution with high universality and enabling the charge to be carried out without the mobile phone, which overcomes the situations that the charge cannot be carried out when being detached from the mobile phone and that the power supply module 101 and the power receiving module 102 must be compatible with each other.

### SUMMARY OF THE INVENTION

A technical problem to be solved in the present invention is to provide a contactless charging device and a charging method to enable batteries detached from a mobile phone to be directly charged by a charger and provide a chargeable battery and a charger with high universality.

To solve the above problems, the invention provides a contactless charging device including a chargeable battery and a charger; the charger comprises: a contactless card reading circuit configured for reading battery characteristic information of the chargeable battery and transmitting the battery characteristic information to a charging control IC during charging; a primary charging circuit configured for transmitting power to the chargeable battery; and a charging control IC configured for controlling the primary charging circuit to supply power to the primary charging circuit according to the battery characteristic information. The chargeable battery comprises: a secondary charging circuit configured for receiving power from the primary charging circuit; and a contactless IC card configured for storing the battery characteristic information of the chargeable battery.

Preferably, the charging device is characterized in that the charging control IC includes a power supply module configured for supplying power to the primary charging circuit. The charger further includes a safety control circuit connected to the charging control IC and configured for real-time measuring temperature of the chargeable battery, sending out a closing signal to close the power supply module when the temperature of the chargeable battery exceed a predetermined temperature, and sending out an opening signal to open the power supply module when the temperature of the chargeable battery is lower than the predetermined temperature.

The charging control IC further includes a charging termination module configured to close the power supply module according to the closing signal; and a charging restarting module configured to open the power supply module according to the opening signal.

Preferably, the battery characteristic information includes charging curve information and secondary charging circuit information. The charging control IC further includes a register that is configured for storing characteristic information of the charge; the characteristic information of the charge including a primary charging circuit information; the power supply module being configured to supply power to the primary charging circuit based on the charging curve, the primary charging circuit information, and the secondary charging circuit information.

Preferably, the battery characteristic information includes authentication information; the charging control IC further including an information validation module configured for validating the authentication information and triggering the power supply module after the authentication information is validated.

Preferably, the charger further includes an effective charging range test module configured for verifying whether the chargeable battery is disposed in an effective charging range of the charger; the effective charging range being determined according to the output power of the contactless card reading circuit.

Preferably, the secondary charging circuit includes a secondary coil, an isolation diode, and an electric cell, which are serially connected in order; the primary charging circuit including a primary coil whose two ends are connected to the charging control IC; the secondary coil receiving power transmitted from the primary coil and transmitting the power to the electric cell via isolation diode.

The invention also provides a chargeable battery comprising: a contactless IC card configured for storing the battery characteristic information of the chargeable battery; and a secondary charging circuit configured for receiving power transmitted by a charger according to the battery characteristic information.

Preferably, the chargeable battery as claimed in claim 8, characterized in that, the secondary charging circuit includes a secondary coil, an isolation diode, and an electric cell, which are serially connected in order; the secondary coil transmitting power received to the electric cell via isolation diode.

Preferably, the battery characteristic information includes charging curve information, secondary charging circuit information, and authentication information.

The invention also provides a charger comprising: a contactless card reading circuit reading battery characteristic information of a chargeable battery; a charging control IC controlling the charger to supply power to the chargeable battery according to the battery characteristic information; and a primary charging circuit configured for transmitting power to the chargeable battery.

Preferably, the charging control IC includes a power supply module configured for supplying power to the primary charging circuit. The charger further comprises a safety control circuit configured for detecting temperature of the chargeable battery, sending out a closing signal to close the power supply module when the temperature of the chargeable battery exceed a predetermined temperature, and sending out an opening signal to open the power supply module when the temperature of the chargeable battery is lower than the predetermined temperature. The charging control IC further includes: a charging termination module configured to close the power supply module according to the closing signal; and a charging restarting module configured to open the power supply module according to the opening signal.

Preferably, the charging control IC further includes a register that is configured for storing characteristic information of the charge; the characteristic information of the charge including a primary charging circuit information. The charger further comprises an effective charging range test module configured for verifying whether the chargeable battery is disposed in an effective charging range of the charger; the effective charging range being determined according to the output power of the contactless card reading circuit.

The invention also provides a charging method using a charging device comprising: placing the chargeable battery in an effective charging range defined by the charger; reading the battery characteristic information by the charger; transmitting power to the chargeable battery according to the battery characteristic information by the charger; receiving the power by the chargeable battery.

The method further comprises real-time detecting temperature of the chargeable battery and sending out a charging terminating signal by the charger when the temperature of the chargeable battery exceeds a predetermined temperature; and stopping power transmission to the chargeable battery by the charger according to the charging terminating signal.

The method further comprises detecting the temperature of the chargeable battery in real time and sending out a charging restarting signal by the charger when the temperature of the chargeable battery turns lower than the predetermined temperature; and restarting the power transmission to the chargeable battery by the charger according to the charging restarting signal.

Preferably, the method further comprises verifying the battery characteristic information by the charger before the power transmission, proceeding to the power transmission if the verification is success, or the charging of the chargeable battery is rejected.

Compared with prior arts, the invention possesses following advantages. The primary coil and the electric cell are assembled in the chargeable battery and the charging control IC is assembled in the charger, the charging control IC can control the primary coil of the charger to transmit power to the secondary coil of the chargeable battery, thereby enabling the chargeable battery detached from a mobile phone to be charged using the charger.

Moreover, the contactless IC card of the chargeable battery stores battery characteristic information. During charging, the contactless card reading circuit obtains the battery characteristic information only by reading the contactless IC. Thus, the charger does not need to particularly match the chargeable battery. That is, the charger can charge many different chargeable batteries from various manufacturers, and the chargeable battery can be also charged by chargers from various manufacturers. As such, high universality of the charger and the chargeable battery is achieved.

### BRIEF DESCRIPTION OF THE DRAWINGS

FIG. 1 shows a typical contactless charging solution in a prior art;

FIG. 2 is a structural diagram of a contactless charging device in an embodiment of the present invention;

FIG. 3 is a schematic diagram of a charging curve in an embodiment of the present invention; and

FIG. 4 is a flow chart of a charging method using a contactless charging device in an embodiment of the present invention.

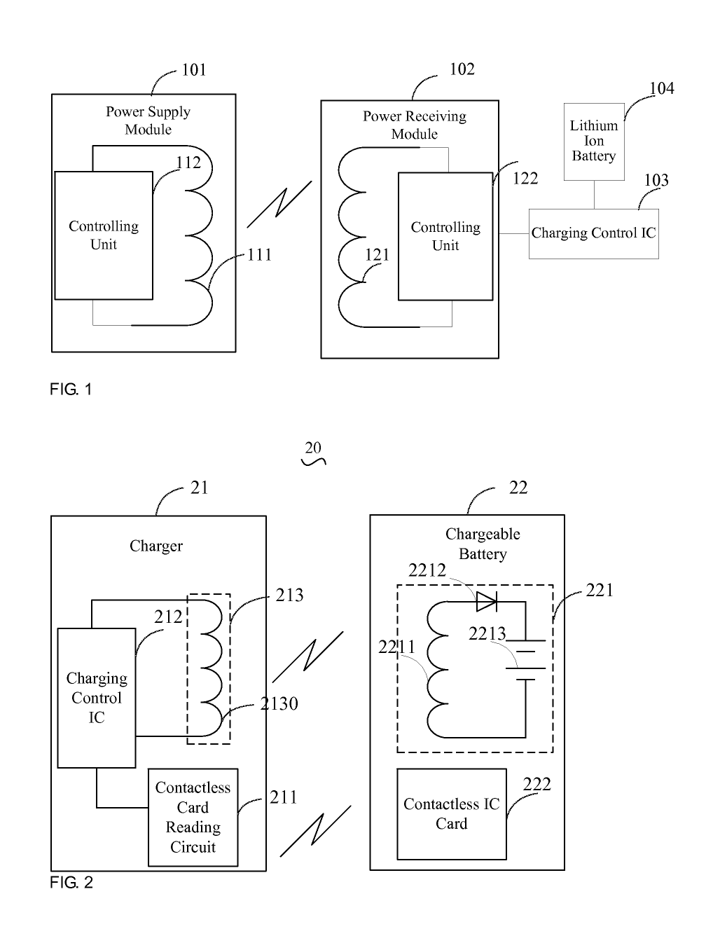

### EMBODIMENTS

The detailed description is presented largely according to drawings and preferred embodiments to explain objections, features, and advantages of the present invention.

One of main ideas of the invention is that a charging control IC is assembled in a charger such that the charger can charge up a chargeable battery detached from a mobile phone. Moreover, a contactless IC card storing battery characteristic information is assembled in the chargeable battery, and a contactless card reading circuit is assembled in the charger. During charging, the contactless card reading circuit reads the contactless IC card to obtain the battery characteristic information, thereby ensure compatibility between the charger and the chargeable battery.

FIG. 2 shows a structure diagram of a contactless charging device 20 in an embodiment. The contactless charging device includes a charger 21 and a chargeable battery 22. The charge 21 includes a contactless card reading circuit 211, a charging control IC 212, and a primary charging circuit 213. The contactless card reading circuit 211 is configured for reading battery characteristic information of the chargeable battery 22 and transmitting the battery characteristic information to the charging control IC 212 during charging. The charging control IC 212 controls the charger 21 to charge the chargeable battery 22. The charging control IC 212 includes a power supply module configured for supplying power to the primary charging circuit 213 according to the battery characteristic information.

The primary charging circuit 213 is configured for transmitting the power to the chargeable battery 22. The chargeable battery 22 may include a secondary charging circuit 221 configured for receiving power from the charger 21 and a contactless IC card 222 storing battery characteristic information of the chargeable battery 22.

The primary charging circuit 213 may include a primary coil 2130, whose two ends are connected to the charging control IC 212. The secondary charging circuit 221 may include a secondary coil 2211, an isolation diode 2212, and an electric cell 2213, which are serially connected in order.

During charging, the secondary coil 2211 receives power transmitted from the primary coil 2130 and transmits the power to the electric cell 2213 via isolation diode 2212 according to one-way conduction characteristic of a diode. As such, the charging of the chargeable battery 22 is implemented.

Taking an application in a mobile phone for example, the secondary coil 2211 and the electric cell 2213 in the contactless charging device 20 are integrated together. The secondary coil 2211 and the electric cell 2213 are very close in plane size. The chargeable battery 22 assembled in such way has a package thickness only 0.8 mm larger than that of a convention battery in a mobile phone but would not do harm to application.

During factual application, battery manufacturers can write the battery characteristic information into the contactless IC card. The battery characteristic information may include following matters: appearance characteristics, discharge performance at 20° C., behavior at high temperature, behavior at low temperature, charge retention, cycle life, environmental suitability, safety performance, safety requirement of battery, and storage requirement. Accordingly, the battery characteristic information may be divided into two types: charging characteristic information and non-charging characteristic information. The charging characteristic information may include type information of the electric cell, battery capability, charging curve, and secondary charging circuit information. The secondary charging circuit information includes parameters referring to the secondary coil, such as, number of turns in the secondary coil, shape, and dimension. The non-charging circuit information includes information about its manufacturer, information about national standards, and security information.

Understandably, the type of the electric cell in the chargeable battery of the invention may be a lithium ion type, a lithium polymer type, or any one of other suitable types. The manufacturer may modulate the number of turns, shape and dimension of the secondary coil according to the battery capability and the physical structure of the battery. For example, the battery capability is higher; accordingly, the number of turns is larger. The shape of the battery may be adaptable to the shape of the secondary coil.

Moreover, the charging characteristic information is essential information of battery and must be recorded during manufacturing. With regard to the non-charging characteristic information, the manufacture may alternatively write it the battery according to industrialization requirement.

The battery characteristic information in one embodiment of the invention may include the charging curve and the secondary charging circuit information. The charging control IC 212 may include a register. The register is configured for storing characteristic information of the charger. The characteristic information of the charger may include a primary charging circuit information.

The manufacture of the charger may write the characteristic information of the charger into the register assembled in the charging control IC in practical application. For instance, number of turns in the primary coil, shape and dimension of the primary coil are written into the register.

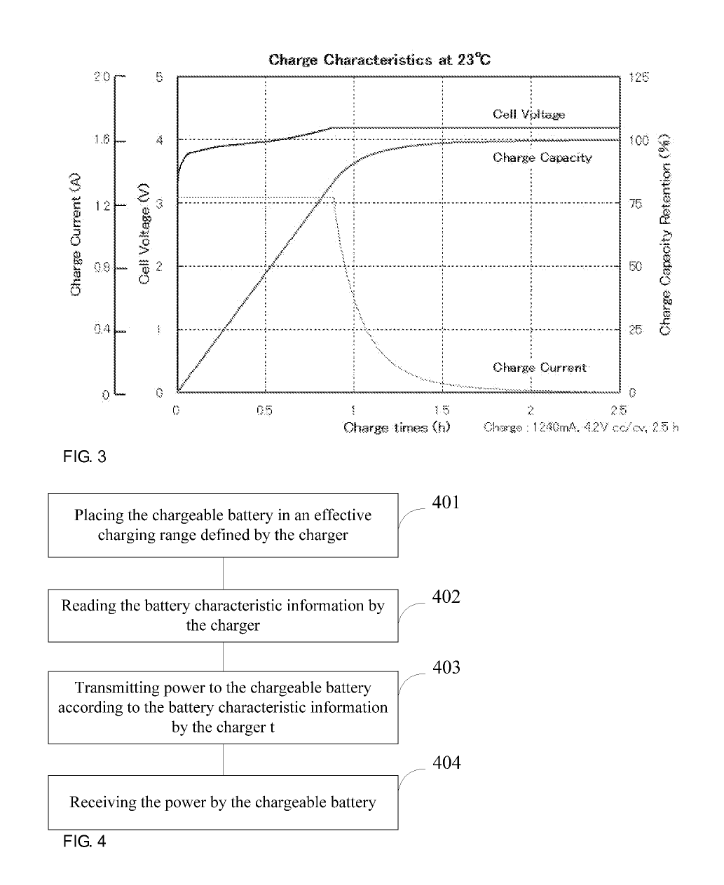

FIG. 3 shows a schematic diagram of the charging curve of the contactless charging device 20 during charging. The charging curve shows charge characteristics at 23° C. A horizontal axis denotes charge time whose unit is hour. A first ordinate axis denotes charge current whose unit is ampere. A second ordinate axis denotes cell voltage whose unit is volt. A third ordinate axis denotes charge capacity retention whose unit is percentage. The charging parameters, 1240 mA, 4.2V cc/cv, 2.5 h shown in a lower right corner of the diagram, are denotes that a constant charge current is 1240 mA, a constant charge voltage is 4.2V, and a charge time is 2.5 h.

A charging process presented by the charging curve includes steps: charging at a constant current of 1240 mA, changing to charging at a constant voltage of 4.2V when the cell voltage rises to 4.2V and finishing the charge after the charge continues for 2.5 h.

The power supply module supply power to the primary charging circuit 213 based on the charging curve, the primary charging circuit information, and the secondary charging circuit information during the charging process, in order to best fit for the charging curve. In factual application, frequency of the power supply, voltage of the power supply, current of the power supply can be adjusted so as to fit the charging process for the charging curve. For example, when the number of turns in the primary coil 2130 is 100, and the number of turns in the secondary coil 2211 is 10, the voltage of the power supply of the primary coil 2130 can be adjusted to 42V during a charging stage at a constant voltage shown in FIG. 3. However, when the number of turns in the primary coil 2130 is 100, and the number of turns in the secondary coil 2211 is 20, the voltage of the power supply of the primary coil 2130 can be adjusted to 21V during the charging stage at the constant voltage.

Understandably, the manufacturer of the charger can adjust the number of turns, dimension, and shape of the primary coil according to the physical structure of the charger. For example, the charger can be shaped in circle or rectangle by adjusting the shape of the primary coil.

In another preferred embodiment, the battery characteristic information includes authentication information. Accordingly, the charging control IC further includes an information validation module configured for validating the authentication information and triggering the power supply module after the authentication information is validated.

The authentication information may be the non-charging characteristic information read by the contactless card reading circuit 211. The working process of the information validation module is that the information validation module verifies whether the chargeable battery can be charged according to the authentication information. For example, if the chargeable battery complies with the national standards (e.g., GB/T 18287-2000) and the security information is validated, the chargeable battery is considered an authorized battery and the power supply module is then triggered. If the chargeable battery does not comply with the national standards (e.g., GB/T 18287-2000) or the security information is invalidated, the chargeable battery should be considered as an invalid battery whose charging request would be refused.

Understandably, the authentication information may include one or more than one of the non-charging characteristic information (e.g., manufacturing information, related national standard, and security information). In another preferred embodiment of the invention, in order to improve safety performance of the contactless charging device, the charger may further include a safety control circuit connected to the charging control IC 212. The safety control circuit is configured for real-time detecting temperature of the chargeable battery 22, sending out a closing signal to close the power supply module when the temperature of the chargeable battery exceed a predetermined temperature, and sending out an opening signal to open the power supply module when the temperature of the chargeable battery is lower than the predetermined temperature.

The charging control IC 212 may further include a charging termination module configured to close the power supply module according to the closing signal and a charging restarting module configured to open the power supply module according to the opening signal. In factual application, a read range of the contactless card reading circuit is a key parameter. Factors that influence the read range of the contactless card reading circuit include operating frequency, RF output power of the contactless card reading circuit, reception sensitivity of the contactless card reading circuit, power consumption of the contactless card reading circuit, Q-value of resonance circuit and antenna, coupling coefficient between the contactless card reading circuit and the contactless IC card, and energy that the contactless IC card sends out and receives.

In order to achieve an effective coupling coefficient between the contactless card reading circuit and the contactless IC card, in a preferred embodiment of the invention, the charger 21 may further include an effective charging range test module (not shown). The effective charging range test module is configured for verifying whether the chargeable battery 22 is disposed in an effective charging range of the charger 21. The effective charging range is determined according to the output power of the contactless card reading circuit 211. The effective charging range test module may be assembled in the charging control IC 212.

For example, the output power of the contactless card reading circuit 211 decrease until only when the distance between the chargeable battery 22 and the charger 21 is lower that 2 mm can the contactless card reading circuit 211 read information from the contactless IC card in the chargeable battery 22. As such, a user would keep the chargeable battery 22 close to the charger 21. Another method to ensure effective coupling between the contactless card reading circuit and the contactless IC card is to adjust orientation of antenna in the contactless card reading circuit 211 to confine the chargeable battery 22 in a designated area (e.g., a central position of the charger). Generally, it is suitable that the contactless IC card 222 is positioned at a central position of the primary charging circuit 213.

An operation process of the contactless charging device is disclosed as following embodiments to enable the skilled in the field to get a better understanding of the invention. A charging method using the charger and the chargeable battery is disclosed. The charging curve of the chargeable battery is shown in FIG. 3. The charging method includes steps S1-S9.

At step S1, the chargeable battery is position in an effective charging range of a charging board (a portion of the primary charging circuit) of the charger. At step S2, the contactless card reading circuit of the charger reads the battery characteristic information preset in factory from the contactless IC card of the chargeable battery and transmits the battery characteristic information to the charging control IC. The battery characteristic information includes:
a) battery capacity 1300 mAh;
b) type of the electric cell, which may be lithium polymer type (charging cut off voltage is 4.2V);
c) charging curve (shown in FIG. 3);
d) secondary charging circuit information including the number of turns of the secondary coil (e.g., ten), internal diameterφ24 mm, and external diameter φ30 mm.

At step S3, the information validation module of the charging control IC verifies the non-charging characteristic information. If verification is successful, the chargeable battery is considered an authorized battery, and then step S4 proceeds. If verification is failed, the chargeable battery is considered an unauthorized battery, and then step S9 proceeds.

The non-charging characteristic information includes manufacturer information, national standards information, and security information.

At step S4, the power supply module reads the primary charging circuit information (e.g., number of turns in the primary coil) and supplies power to the primary charging circuit according to the charging curve, the primary charging circuit information, and the secondary charging circuit information. At step S5, the primary charging circuit transmits power to the secondary charging circuit of the chargeable battery by electromagnetic coupling.

At step S6, the safety control circuit of the charger detects the real-time temperature of the chargeable battery during charging. If the temperature of the chargeable battery exceeds a predetermined temperature, step S7 proceeds. At step S7, the safety control circuit sends out a closing signal, and the charging termination module closes the power supply module according to the closing signal. At step S8, the safety control circuit detects the temperature of the chargeable battery in real time after stopping the charging and sends out an opening signal when the temperature of the chargeable battery becomes lower than the predetermined temperature. The charging restarting module restarts the power supply module according to the opening signal. Step S4 then proceeds. At step S9, the charging of the chargeable battery is rejected.

It should be understandable that the skilled in the art can mount a charging indicator lamp onto the charger as required. The charging indicator lamp may be red when the chargeable battery has not attained to its full capacity. The charging indicator lamp may turn yellow when the chargeable battery attains to its full capacity. The closing signal can also be generated when the chargeable battery reaches its full capacity. The charging termination module closes the power supply module according to the closing signal so as to save power.

The embodiments of the invention can be applied to any charging device suitable for mobile devices, such as personal handy-phone systems, personal digital assistants, and mobile game players. In this situation, the same effects can be obtained. The invention also provides a chargeable battery in an embodiment. The chargeable battery may include: the contactless IC card configured for storing the battery characteristic information; and the secondary charging circuit configured for receiving power transmitted by the charger according to the battery characteristic information during charging. Particularly, the secondary charging circuit may be a loop including the secondary coil, the isolation diode, and the electric cell, which are serially connected in order. The secondary coil transmits the received power to the electric cell via the isolation diode according to one-way conduction characteristic of a diode.

Factually, the manufacturer of the chargeable battery may write the battery characteristic information into the contactless IC card of the chargeable battery according to industrial standards in the art. The battery characteristic information in a preferred embodiment includes the charging curve, the secondary charging circuit information, and the authentication information. During charging, the charger determines whether to charge the chargeable battery or not according to the authentication information and supplies power to the primary charging circuit of the charger according to the charging curve, the secondary charging circuit information, and the characteristic information of the charger.

The explanation about the chargeable battery refers to the above description on the contactless charging device 21 shown in FIG. 2. The invention also provides a charger including: a contactless card reading circuit configured for reading battery characteristic information of the chargeable battery and transmitting the battery characteristic information to the charging control IC during charging; a charging control IC comprising a power supply module configured for supplying power to the primary charging circuit according to the battery characteristic information; and a primary charging circuit configured for transmitting the power to the chargeable battery.

In order to improve the security performance of the contactless charging, the charger in a preferred embodiment of the invention may further include a safety control circuit connected to the charging control IC and configured for detecting the temperature of the chargeable battery in real time, sending out a close signal for closing the power supply module when the temperature of the chargeable battery exceeds a predetermined temperature, and sending out an opening signal for restarting the power supply module when the temperature of the chargeable battery turns lower than the predetermined temperature.

In this case, the charging control IC may further include: a charging termination module configured for stopping the power supply module according to the closing signal; and a charging restarting module configured for restarting the power supply module according the opening signal.

In order to achieve an effective coupling coefficient between the charger and the chargeable battery, the charging control IC may further include a register configured for storing characteristic information of the charger. The characteristic information of the charger may include a primary charging circuit information (e.g., number of turns in the primary coil). In this case, the power supply module supplies power to the primary charging circuit according to the primary charging circuit information and the battery characteristic information, thereby realizing the power transmission from the charger to the chargeable battery.

In order to achieve a better coupling coefficient between the charger and the chargeable battery, in another preferred embodiment of the invention, the charger may further include an effective charging range test module configured for verifying whether the chargeable battery is disposed in an effective charging range of the charger. The effective charging range is determined according to the output power of the contactless card reading circuit.

For example, the output power of the contactless card reading circuit decrease until only when the distance between the chargeable battery and the charger is lower that 2 mm can the contactless card reading circuit read information from the contactless IC card in the chargeable battery. As such, a user is induced to keep the chargeable battery close to the charger by the above manner.

Another method to ensure effective coupling between the contactless card reading circuit and the contactless IC card is to adjust orientation of antenna in the contactless card reading circuit 211 to confine the chargeable battery 22 in a designated area (e.g., a central position of the charger). Generally, it is suitable that the contactless IC card 222 is positioned at a central position of the primary charging circuit 213.

The explanation about the chargeable refers to the above description on the contactless charging device 21 shown in FIG. 2. Referring to FIG. 4, a flow chart of a charging method using the contactless charging device in an embodiment of the present invention is shown. The charging method may include: step 401, placing the chargeable battery in an effective charging range defined by the charger; step 402, reading the battery characteristic information by the charger; step 403, transmitting power to the chargeable battery according to the battery characteristic information by the charger; step 404, receiving the power by the chargeable battery.

In factual application, the effective charging range can be marked by an image label on a charging board (a portion of the primary charging circuit) of the charger. In order to improve security performance of the contactless charging device, the charging method may further include: the charger detecting temperature of the chargeable battery and sending out a charging terminating signal when the temperature of the chargeable battery exceeds a predetermined temperature; and the charger stopping power transmission to the chargeable battery according to the charging terminating signal.

After stopping the power transmission to the chargeable battery, the charger may also detect the temperature of the chargeable battery in real time and generate a charging restarting signal when the temperature of the chargeable battery turns lower than the predetermined temperature. The charger restarts the power transmission to the chargeable battery according to the charging restarting signal.

The charging method in another preferred embodiment of the invention may further include a step at which the charger verifies the battery characteristic information. The power transmission proceeds if the verification is success, or the charging of the chargeable battery is rejected.

For example, the chargeable battery is considered an authorized battery, and the power transmission proceeds if the chargeable battery complies with the national standards (e.g., GB/T 18287-2000), or the chargeable battery is considered an unauthorized battery, and the charging is rejected.

A contactless charging device, a charging method, a chargeable battery, and a charger have been detailed in the above descriptions. The principle and realization of the invention have been described by way of examples, which are only presented to facilitate understanding of the methodology and the substance of the invention. Numerous changes in the embodiments and the application areas can be made by those skilled in the art according to the substance of the invention. Accordingly, the foregoing description of embodiments should not be considered as definition of the scope of the present invention.

I claim:

1. A contactless charging device including a chargeable battery and a charger, characterized in that:
the charger comprising:
a contactless card reading circuit configured for reading battery characteristic information of the chargeable battery and transmitting the battery characteristic information to a charging control IC during charging;
a primary charging circuit configured for transmitting power to the chargeable battery; and
a charging control IC configured for controlling the primary charging circuit to supply power to the primary charging circuit according to the battery characteristic information;
the chargeable battery comprising:
a secondary charging circuit configured for receiving power from the primary charging circuit; and
a contactless IC card configured for storing the battery characteristic information of the chargeable battery.

2. The charging device as claimed in claim 1, characterized in that, the charging control IC includes a power supply module configured for supplying power to the primary charging circuit.

3. The charging device as claimed in claim 2, characterized in that, the charger further includes a safety control circuit connected to the charging control IC and configured for real-time measuring temperature of the chargeable battery, sending out a closing signal to close the power supply module when the temperature of the chargeable battery exceed a predetermined temperature, and sending out an opening signal to open the power supply module when the temperature of the chargeable battery is lower than the predetermined temperature;
the charging control IC further including:
a charging termination module configured to close the power supply module according to the closing signal; and
a charging restarting module configured to open the power supply module according to the opening signal.

4. The charging device as claimed in claim 2, characterized in that, the battery characteristic information includes charging curve information and secondary charging circuit information;
the charging control IC further including a register that is configured for storing characteristic information of the charge; the characteristic information of the charge including a primary charging circuit information;
the power supply module being configured to supply power to the primary charging circuit based on the charging curve, the primary charging circuit information, and the secondary charging circuit information.

5. The charging device as claimed in claim 2, characterized in that, the battery characteristic information includes authentication information;
the charging control IC further including an information validation module configured for validating the authentication information and triggering the power supply module after the authentication information is validated.

6. The charging device as claimed in claim 1, characterized in that, the charger further includes an effective charging range test module configured for verifying whether the chargeable battery is disposed in an effective charging range of the charger; the effective charging range being determined according to the output power of the contactless card reading circuit.

7. The charging device as claimed in claim 1, characterized in that, the secondary charging circuit includes a secondary coil, an isolation diode, and an electric cell, which are serially connected in order; the primary charging circuit including a primary coil whose two ends are connected to the charging control IC;
the secondary coil receiving power transmitted from the primary coil and transmitting the power to the electric cell via isolation diode.

8. a chargeable battery, characterized in that, comprising:
a contactless IC card configured for storing the battery characteristic information of the chargeable battery; and
a secondary charging circuit configured for receiving power transmitted by a charger according to the battery characteristic information.

9. The chargeable battery as claimed in claim 8, characterized in that, the secondary charging circuit includes a secondary coil, an isolation diode, and an electric cell, which are serially connected in order;
the secondary coil transmitting power received to the electric cell via isolation diode.

10. The chargeable battery as claimed in claim 8, characterized in that, the battery characteristic information includes charging curve information, secondary charging circuit information, and authentication information.

11. a charger, characterized in that, comprising:
a contactless card reading circuit reading battery characteristic information of a chargeable battery;
a charging control IC controlling the charger to supply power to the chargeable battery according to the battery characteristic information; and
a primary charging circuit configured for transmitting power to the chargeable battery.

12. The charger as claimed in claim 11, characterized in that, the charging control IC includes a power supply module configured for supplying power to the primary charging circuit.

13. The charger as claimed in claim 11, characterized in that, further comprising a safety control circuit configured for detecting temperature of the chargeable battery, sending out a closing signal to close the power supply module when the temperature of the chargeable battery exceed a predetermined temperature, and sending out an opening signal to open the power supply module when the temperature of the chargeable battery is lower than the predetermined temperature;
the charging control IC further including:
a charging termination module configured to close the power supply module according to the closing signal; and
a charging restarting module configured to open the power supply module according to the opening signal.

14. The charger as claimed in claim 11, characterized in that, the charging control IC further including a register that is configured for storing characteristic information of the charge; the characteristic information of the charge including a primary charging circuit information.

15. The charger as claimed in claim 11, characterized in that, further comprising an effective charging range test module configured for verifying whether the chargeable battery is disposed in an effective charging range of the charger; the effective charging range being determined according to the output power of the contactless card reading circuit.

16. The charging method using the charging device as claimed in claim 1, characterized in that, comprising:
placing the chargeable battery in an effective charging range defined by the charger;
reading the battery characteristic information by the charger;
transmitting power to the chargeable battery according to the battery characteristic information by the charger;
receiving the power by the chargeable battery.

17. The method as claimed in claim 16, characterized in that, further comprising:
real-time detecting temperature of the chargeable battery and sending out a charging terminating signal by the charger when the temperature of the chargeable battery exceeds a predetermined temperature; and
stopping power transmission to the chargeable battery by the charger according to the charging terminating signal.

18. The method as claimed in claim 17, characterized in that, further comprising:
detecting the temperature of the chargeable battery in real time and sending out a charging restarting signal by the charger when the temperature of the chargeable battery turns lower than the predetermined temperature;
restarting the power transmission to the chargeable battery by the charger according to the charging restarting signal.

19. The method as claimed in claim 16, characterized in that, before the power transmission, further comprising:
verifying the battery characteristic information by the charger;
proceeding to the power transmission if the verification is success, or the charging of the chargeable battery is rejected.
